(19) United States
(12) Patent Application Publication
(10) Pub. No.: US 2026/0142862 A1
(43) Pub. Date: May 21, 2026

(54) A METHOD FOR REMAPPING A TIME-CONTINUOUS SIGNAL TO ONE OR MORE TIME-FREQUENCY SPACE COEFFICIENTS AND DEVICES THEREFORE

(71) Applicants: Henrik Jörntell, Lund (SE); Kaan Kesgin, Malmö (SE)

(72) Inventors: Henrik Jörntell, Lund (SE); Kaan Kesgin, Malmö (SE)

(21) Appl. No.: 19/121,451

(22) PCT Filed: Oct. 6, 2023
(86) PCT No.: PCT/SE2023/051001

§ 371 Date: Apr. 16, 2025

(30) Foreign Application Priority Data
Oct. 17, 2022 (SE) 2230334-1

(51) Int. Cl. H04L 27/26; H04L 27/04; H04L 27/20

(52) U.S. Cl. CPC H04L 27/2642; H04L 27/04; H04L 27/20; H04L 27/2639

(57) ABSTRACT

The disclosure relates to a remapping unit (100) configured to remap a time-continuous signal to one or more time-frequency space coefficients, the remapping unit comprising: a transform unit (110) configured to receive the time-continuous signal and a frequency band of interest, and configured to multiply the received time-continuous signal with a window function having a window size, the window function comprising one or more basis functions; an integrating unit (120) configured to integrate the window function with infinitesimally small increments in the window size to obtain an integral; and wherein the transform unit (110) is configured to remap the time continuous signal to one or more time frequency space coefficients based on the integral. The disclosure further relates to a receiver, an inverse remapping unit, a transmitter, systems, a repeater, methods, computer program products, and a non-transitory computer-readable storage medium.

### TECHNICAL FIELD

The present disclosure relates to a method for remapping a time-continuous signal to one or more time-frequency space coefficients utilizing a transform, a transmitter, an inverse remapping unit, a receiver, systems, a repeater, methods, a computer program product, and a non-transitory computer-readable storage medium therefor. More specifically, the disclosure relates to a method for remapping a time-continuous signal to one or more time-frequency space coefficients utilizing a transform, a transmitter, an inverse remapping unit, a receiver, systems, a repeater, methods, a computer program product, and a non-transitory computer-readable storage medium as defined in the introductory parts of the independent claims.

### BACKGROUND ART

One way of remapping time-continuous signals to time-frequency space is by utilizing Fast Fourier Transform (FFT). The resulting time-frequency data can be used to identify “signatures” of specific events in the time-continuous signal(s), which can be useful for data processing, such as object/pattern recognition and/or separation of specific signals/signatures originating from different sources but superimposed on the same time-continuous signal. Furthermore, the resulting time-frequency data may represent a reduction of the original time-continuous data. Therefore, FFT can be used for data compression, which is useful for data transmission, for example in wireline/wired (i.e., over cables) or wireless communication. One approach to achieve efficient wireless data transmission is by utilizing OFDM (Orthogonal Frequency-Division Multiplexing). However, in some applications, the resolution in the time-frequency space (after OFDM) may not be high enough, and therefore the OFDM may not be efficient enough.

The resolution of FFT is a trade-off between frequency resolution and time resolution. Thus, it may be difficult to increase frequency resolution without decreasing time resolution and vice versa. Therefore, data transmission, e.g., wireless data transmission, utilizing FFT may not provide for sufficient bandwidth, or it may consume an unnecessary amount of energy for a given desired bandwidth of data transmission. Furthermore, data processing utilizing FFT, e.g., for identification of measurable characteristics of objects or signatures in the data may not be precise/accurate enough, and therefore not reliable enough and/or not having enough capacity to handle more complex data, e.g., with multiple overlaid data signatures.

Alternatives to traditional FFT to reduce these limitations exist. The continuous wavelet transform (CWT) is based on designing a complex wavelet, e.g., a “Morlet” wave, which can be scaled to cover different frequency bands. For each frequency band of interest, the frequency-scaled wavelet is used to represent the data. However, the CWT still has limited time-frequency resolution.

A recent improvement of CWT has been published (Moca V. V. et al.: “Time-frequency super-resolution with superlets”) and can be found at e.g., https://www.nature.com/articles/s41467-020-20539-9. It is called the superlet transform (SLT). SLT increases resolution by gradually increasing the length of the Morlet wave in a discrete manner, i.e., by gradually increasing the number of cycles of the Morlet wave for each frequency band of interest. SLT can provide a dramatically improved resolution in the time-frequency space over prior art, such as CWT. However, because SLT involves iteration (since there is a gradual, discrete increase in the number of cycles in the Morlet wave), it is computationally expensive. Moreover, in high frequencies (such as frequencies within the kHz range, e.g., 1-1000 kHz, or within the MHz range, e.g., 1-1000 MHz, or above) the frequency resolution becomes highly limited, or the transformation process becomes so computationally expensive that it is presently not a feasible approach.

Further prior art is described in EP 3324592 A1, and in Harald Barzan et al., “fractional superlets”, published in 2020 28th European Signal Processing Conference (EUSIPCO), https://ieeexplore.ieee.org/document/9287873.

Therefore, there may be a need to overcome the limitations of SLT (e.g., computational expensiveness/costliness). Furthermore, there may be a need to provide more efficient OFDM. There may also be a need to increase the resolution in both frequency and time domains. Moreover, there may be a need to increase the reliability of data processing and/or increase the capacity of data processing to handle more complex data. There may, further, be a need for providing less computationally expensive methods for data processing or for transmission of data, such as wireless transmission of data. Furthermore, there may be a need for methods (and devices) providing a faster transmission of data.

### SUMMARY

An object of the present disclosure is to mitigate, alleviate or eliminate one or more of the above-identified deficiencies and disadvantages in prior art and solve at least the above-mentioned problem(s).

According to a first aspect there is provided a remapping unit for remapping a time-continuous signal to one or more time-frequency space coefficients utilizing a transform, the remapping unit comprising: a transform unit configured to receive the time-continuous signal and a frequency band of interest, and configured to multiply the received time-continuous signal with a window function having a window size, the window function comprising one or more functions; an integrating unit configured to integrate the window function with infinitesimally small increments in the window size to obtain an integral; and the transform unit is configured to remap the time-continuous signal to one or more time-frequency space coefficients based on the integral. By integrating the window function with infinitesimally small increments in the window size, a more efficient remapping is provided, e.g., since the integral can be calculated in one iteration instead of in many iterations.

According to some embodiments, the one or more functions is one or more sinusoidal functions, one or more Morlet wavelets, or one or more modified complex Morlet wavelets.

According to some embodiments, the window function is integrated with infinitesimally small increments in the window size by utilizing a pre-defined antiderivative function of the integrand of the integral, calculating the antiderivative function with an upper bound of integration to obtain a first function value, calculating the antiderivative function with a lower bound of integration to obtain a second function value, and calculating the integral as the difference between the first and the second function values.

According to some embodiments, the window function is integrated with infinitesimally small increments in the window size by utilizing a pre-defined antiderivative function of the integrand of the integral, calculating the antiderivative function with an upper bound of a sub-range of the frequency band of interest to obtain a first function value, calculating the antiderivative function with a lower bound of a sub-range of the frequency band of interest to obtain a second function value, and calculating the integral as the difference between the first and the second function values.

According to some embodiments, the window function is integrated with infinitesimally small increments in the window size by approximating the window function with a power series and finding a limit of the power series and utilize the limit as the integral.

According to some embodiments, the window function is integrated with infinitesimally small increments in the window size by finding the limit of a known power series and utilizing the limit as the integral.

According to some embodiments, the window function is integrated with infinitesimally small increments in the window size by utilizing a pre-defined antiderivative function of the integrand of the integral, calculating the antiderivative function with an upper bound of integration to obtain a first function value, calculating the antiderivative function with a lower bound of integration to obtain a second function value, and calculating a first integral as the difference between the first and the second function values, by approximating the window function with a power series and finding a limit of the power series and utilize the limit as a second integral, and the integrating unit is configured to select a mean value or a median value of the first and second integrals as the integral.

According to some embodiments, the integral is part of the calculations performed for the remapping.

According to some embodiments, the integral is part of an equation to be solved for the remapping.

According to some embodiments, the transform is a Fourier-related transform, such as a windowed Fourier transform or a Hartley transform, or a continuous wavelet transform, CWT, or a superlet transform, SLT.

According to a second aspect there is provided a transmitter for wireline communication or for wireless transmission comprising the remapping unit of the first aspect or any of the above-mentioned embodiments.

According to a third aspect there is provided an inverse remapping unit for remapping one or more time-frequency space coefficients to a time-continuous signal utilizing an inverse 5 transform, the inverse remapping unit comprising: an inverse transform unit configured to receive one or more time-frequency space coefficients and configured to inverse-multiply the received time-continuous signal with a window function having a window size, the window function comprising one or more functions; an integrating unit configured to integrate the window function with infinitesimally small increments in the window size to obtain an integral; and the inverse transform unit is configured to remap the one or more time-frequency space coefficients to a time-continuous signal based on the integral.

According to a fourth aspect there is provided a receiver for wireline communication or for wireless transmission comprising the inverse remapping unit of the third aspect or any embodiment corresponding to one of the above-mentioned embodiments.

According to a fifth aspect there is provided a system for wireline communication or for wireless transmission, comprising: the transmitter of the second aspect further comprising a modulator configured to modulate the one or more time-frequency space coefficients with a carrier signal; and the receiver of the fourth aspect further comprising a demodulator configured to demodulate the modulated carrier signal to extract the one or more time-frequency space coefficients.

According to a sixth aspect there is provided computer-implemented or hardware-implemented method for remapping a time-continuous signal to one or more time-frequency space coefficients, comprising: receiving a time-continuous signal and a frequency band of interest; multiplying the received time-continuous signal with a window function having a window size, the window function comprising one or more functions; integrating the window function with infinitesimally small increments in the window size to obtain an integral; and remapping the received time-continuous signal to one or more time-frequency space coefficients based on the integral.

According to a seventh aspect there is provided computer-implemented or hardware-implemented method for wireline communication or for wireless transmission, comprising: receiving a time-continuous signal and a frequency band of interest; multiplying the received time-continuous signal with a window function having a window size, the window function comprising one or more functions; integrating the window function with infinitesimally small increments in the window size to obtain an integral; remapping the received time-continuous signal to one or more time-frequency space coefficients based on the integral; and modulating the one or more time-frequency space coefficients with a carrier signal.

According to an eighth aspect there is provided a computer program product comprising a non-transitory computer readable medium, having stored thereon a computer program comprising program instructions, the computer program being loadable into a data processing unit and configured to cause execution of the method of the sixth aspect, the seventh aspect, or any of the above mentioned embodiments (or embodiments corresponding thereto) when the computer program is run by the data processing unit.

According to a ninth aspect there is provided a program product comprising instructions, which, when executed on at least one processor of a processing device, cause the processing device to carry out the method according to the sixth aspect, the seventh aspect, or any of the embodiments mentioned herein.

According to a tenth aspect there is provided a non-transitory computer-readable storage medium storing one or more programs configured to be executed by one or more processors of a processing device, the one or more programs comprising instructions which, when executed by the processing device, causes the processing device to carry out the method according to the sixth aspect, the seventh aspect, or any of the embodiments mentioned herein.

According to an eleventh aspect there is provided a data processing system comprising: the remapping unit of the first aspect or any of the above-mentioned embodiments; a memory unit comprising: two or more sets of known time-frequency space coefficients; and two or more signatures/patterns, wherein each signature/pattern is associated with a corresponding set of time-frequency space coefficients; and an identification unit, connected to the memory unit, the identification unit being configured to identify signatures and/or to recognize patterns in the time-continuous signal by comparing the one or more time-frequency space coefficients to the two or more stored sets of time-frequency space coefficients to find a closest match of the one or more time-frequency space coefficients to the stored two or more sets of time-frequency space coefficients, and identify/recognize the signature/pattern as the stored signature/pattern which is associated with the stored set of time-frequency space coefficients which is the closest match for the one or more time-frequency space coefficients.

Effects and features of the second, third, fourth, fifth, sixth, seventh, eighth, ninth, tenth, and eleventh aspects are to a large extent analogous to those described above in connection with the first aspect and vice versa. Embodiments mentioned in relation to the first aspect are largely or fully compatible with the second, third, fourth, fifth, sixth, seventh, eighth, ninth, tenth, and eleventh aspects and vice versa.

An advantage of some embodiments is that time-frequency resolution is improved/increased.

An advantage of some embodiments is that energy consumption to achieve a given desired time-frequency resolution is lowered/decreased.

A further advantage of some embodiments is that computational cost to perform data transformation, in particular for signals in high frequencies (e.g., frequencies above 1 kHz, 1 MHz or 1 GHz), is reduced, thus providing faster data transformation.

Yet a further advantage of some embodiments is that the precision in signature identification or object identification in time continuous data is improved/increased.

Another advantage of some embodiments is that more efficient OFDM is provided.

Yet another advantage of some embodiments is that the resolution in both the frequency domain and the time domain is improved/increased.

Another further advantage of some embodiments is that the reliability of data processing and/or the capacity of data processing to handle more complex data is improved/increased.

Yet another further advantage of some embodiments is that less computationally expensive methods for data processing or for transmission of data, such as wireless transmission of data, are provided.

Furthermore, another advantage of some embodiments is that faster transmission of data and/or transmission of more data during the same time period is provided.

Moreover, another advantage of some embodiments is that improved/increased bandwidth is provided, or that less energy is needed for a given desired bandwidth of data transmission.

Another advantage of some embodiments is improved/increased efficiency of remapping.

Other advantages of some of the embodiments are improved performance, higher/increased reliability, increased precision, increased efficiency, less computer power needed, less storage space needed, less complexity and/or lower energy consumption.

The present disclosure will become apparent from the detailed description given below. The detailed description and specific examples disclose preferred embodiments of the disclosure by way of illustration only. Those skilled in the art understand from guidance in the detailed description that changes, and modifications may be made within the scope of the disclosure.

Hence, it is to be understood that the herein disclosed disclosure is not limited to the particular component parts of the device described or steps of the methods described since such apparatus and method may vary. It is also to be understood that the terminology used herein is for purpose of describing particular embodiments only and is not intended to be limiting. It should be noted that, as used in the specification and the appended claim, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps. Furthermore, the term “configured” or “adapted” is intended to mean that a unit or similar is shaped, sized, connected, connectable or otherwise adjusted for a purpose.

### BRIEF DESCRIPTIONS OF THE DRAWINGS

The above objects, as well as additional objects, features, and advantages of the present disclosure, will be more fully appreciated by reference to the following illustrative and non-limiting detailed description of example embodiments of the present disclosure, when taken in conjunction with the accompanying drawings.

FIG. 1 is a schematic block diagram illustrating a remapping unit according to some embodiments;

FIG. 2 is a schematic block diagram illustrating an inverse remapping unit according to some embodiments;

FIG. 3 is a schematic block diagram illustrating a system for wireless transmission according to some embodiments;

FIG. 4 is a flowchart illustrating method steps according to some embodiments;

FIG. 5 is a flowchart illustrating method steps according to some embodiments;

FIG. 6 is a flowchart illustrating method steps implemented in an apparatus for remapping a time-continuous signal to one or more time-frequency space coefficients, in a wireless device or in a control unit/control circuitry thereof, according to some embodiments;

FIG. 7 is a flowchart illustrating method steps implemented in an apparatus for wireless transmission, in a wireless device or in a control unit/control circuitry thereof, according to some embodiments;

FIG. 8 is a schematic drawing illustrating an example computer readable medium according to some embodiments;

FIG. 9 is a flowchart illustrating method steps according to some embodiments;

FIG. 10 is a flowchart illustrating method steps implemented in an apparatus for wireless transmission, in a wireless device or in a control unit/control circuitry thereof, according to some embodiments;

FIG. 11 is a schematic drawing illustrating a data processing system according to some embodiments;

FIG. 12A is a graph illustrating the relation between time and power for a higher-temporal resolution Morlet wavelet, a higher-frequency-resolution Morlet wavelet and a singular integrated-wavelet; and

FIG. 12B is a graph illustrating the relation between frequency and power for a higher-temporal resolution Morlet wavelet, a higher-frequency-resolution Morlet wavelet and a singular integrated-wavelet.

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

### Terminology

Below is referred to a “signature”. A signature is a distribution of data across specific frequencies with a specific temporal relationship in that frequency distribution.

Below is referred to a “window function”. A window function is a mathematical function that is zero-valued outside of some chosen interval but has a value different from zero for at least some frequency within the chosen interval. The window function may be symmetric around the middle of the interval, e.g., near a maximum in the middle. Furthermore, the window function may be tapering away from the middle. A window function may also be an apodization function or a tapering function.

Below is referred to a “frequency band”. A frequency band is an interval in the frequency domain, delimited by a lower frequency and an upper frequency.

Below is referred to a “lower bound”. A lower bound of a frequency band/interval is the lower frequency delimiting the frequency band.

Below is referred to an “upper bound”. An upper bound of a frequency band/interval is the upper frequency delimiting the frequency band.

Below is referred to a “limit”. A limit is the value (or set/array of values) that a function or sequence approaches as the input (or index) approaches some value, such as infinity.

### Embodiments

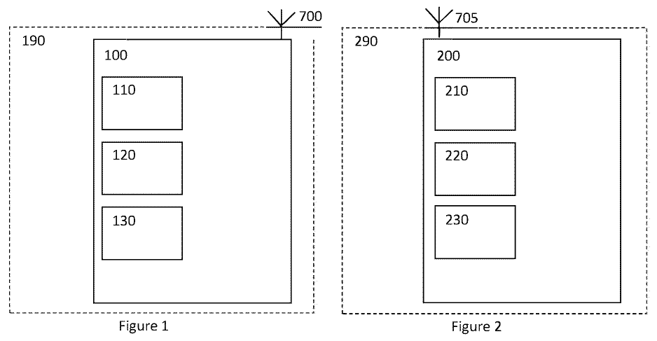

In the following, embodiments will be described where FIG. 1 is a schematic block diagram illustrating a remapping unit 100 according to some embodiments. The remapping unit 100 is (configured) for remapping a time-continuous signal to one or more time-frequency space coefficients utilizing a transform. The remapping unit 100 comprises a transform unit 110. The transform unit 110 receives or is configured to receive the time-continuous signal. Furthermore, the transform unit 110 receives or is configured to receive a frequency band of interest. The frequency band of interest has a lower bound and an upper bound. Thus, in some embodiments, the transform unit 110 receives or is configured to receive the lower bound and the upper bound. Furthermore, in some embodiments, the frequency band of interest and/or the lower bound and/or the upper bound is within the range of 1 kHz-100 GHz, e.g., within the range of 10 kHz-10 GHz, such as within the range of 10 kHz-100 kHz or within the range of 100 kHz-1 MHz or within the range of 1 MHz-10 MHz or within the range of 10 MHz-100 MHz or within the range of 100 MHz-1 GHz or within the range of 1 GHZ-10 GHz or within the range of 10 GHz-100 GHz. Moreover, the transform unit 110 is configured to multiply the received time-continuous signal with a window function, e.g., according to a transform. The window function has a window size (or window length/width) L. The window size is, in some embodiments, defined as the difference between an upper bound (or second endpoint) of the window and a lower bound (or first endpoint or start point) of the window. Furthermore, in some embodiments, the window size is the same as utilized for existing methods of remapping time-continuous signals to time-frequency space. In some embodiments, the window function is a time window function. The window function comprises one or more functions. In some embodiments, the one or more functions are or comprises one or more basis functions. In some embodiments, the one or more basis functions are or comprises one or more sinusoidal basis functions. Alternatively, the one or more (basis) functions are or comprises one or more Morlet (or Gabor) wavelets. As another alternative, the one or more (basis) functions are or comprises one or more modified complex Morlet wavelets. As yet another alternative, the one or more (basis) functions are or comprises one or more sinusoidal basis functions, one or more Morlet wavelets, and/or one or more modified complex Morlet wavelets. In some embodiments, the transform is a Fourier-related transform. The Fourier-related transform is a windowed Fourier transform, a short-term fast Fourier transform (FFT), a Hartley transform, a variable-Q transform (VQT) or a constant-Q transform (CQT). Alternatively, the transform is a continuous wavelet transform (CWT). As another alternative, the transform is a superlet transform (SLT). The remapping unit 100 comprises an integrating unit 120. The integrating unit 120 integrates or is configured to integrate the window function with infinitesimally small increments in the window size to obtain an integral (e.g., an integral value or an array of integral values). The integral may be an integral of the window function from a lower bound to an upper bound of the frequency range of interest. Thus, the integrating unit may receive the lower and upper bounds, e.g., from the transform unit 110. Moreover, the integrating unit 120 may receive the window function from a memory unit external to the integrating unit 120, e.g., comprised in the remapping unit 100. Alternatively, the window function is stored internally in the integrating unit 120. Furthermore, the integral may be an integral which needs to be calculated in order to transform the time-continuous signal, i.e., the integral may be part of the calculations performed/made and/or part of the equation solved for transforming/remapping a time-continuous signal to one or more time-frequency space coefficients, e.g., according to a Fourier-related transform, CWT or SLT. I.e., in some embodiments, the transforming/remapping comprises (or consists of) performing calculations and/or solving an equation. The calculations to be performed and/or the equation to be solved depends on whether the transform is a Fourier-related transform, a CWT or an SLT (i.e., the equations/calculations are in accordance with or identical to any known equations/calculations for performing Fourier-related transforming, CWT and/or SLT).

As an example, if the transform is an SLT, the equation (including the integral) to be solved is:

$${S}_{a}^{b} ( x , {f}_{c} ) = \frac{x ( t )}{b - a} * {\int }_{a}^{b} {e}^{- {( {tk}_{s d} {f}_{c} π \sqrt{2} / n )}^{2}} {e}^{2 π j {f}_{c} t} d n$$

wherein x(t) is the input vector, f_{c} is the central frequency or frequency of interest, a is the lower bound (or first endpoint) of the window (or number of cycles), b is the upper bound (or second endpoint) of the window (or number of cycles), t is time, k_{sd} is the standard deviation of the Gaussian envelope, n is the number of cycles, e^{-(tk}^{_{sd}}^{f}^{_{c}}^{π\sqrt{2}/n)}^{²} e^{2πjf}^{_{c}}^{t} is the integrand, and

$${\int }_{a}^{b} {e}^{- {( {tk}_{s d} {f}_{c} π \sqrt{2} / n )}^{2}} {e}^{2 π j {f}_{c} t} d n$$

is the integral. Calculations other than the integration may involve only division, subtraction, multiplication, and addition (as can be seen from the equation given above).

By integrating the window function with infinitesimally small increments in the window size, a more efficient remapping is provided, e.g., since the integral can be calculated in one iteration instead of in many iterations. In some embodiments (first approach), the integrating unit 120 integrates the window function with infinitesimally small increments in the window size by utilizing a pre-defined antiderivative function of the integrand of the integral (of the window function), by calculating the antiderivative function with the upper bound of integration (i.e., the upper bound of the frequency band of interest) to obtain a first function value (or a first array of function values), by calculating the antiderivative function with the lower bound of integration (i.e., the lower bound of the frequency band of interest) to obtain a second function value (or a second array of function values), and by calculating/obtaining the integral as the difference between the first and the second function values (or as the difference between the first and the second arrays). Alternatively (second approach), the first function value is obtained by calculating the antiderivative function with an upper bound of a sub-range of the frequency band of interest, and the second function value is obtained by calculating the antiderivative function with a lower bound of a sub-range of the frequency band of interest. In some embodiments, one or more pre-defined antiderivative functions are stored in a memory together with an associated window function. The memory is comprised in or associated with the integrating unit 120 or the remapping unit 100. Thus, the integrating unit 120 may retrieve the pre-defined antiderivative function associated with the window function directly from the memory. Furthermore, in some embodiments, the pre-defined antiderivative function of the integrand of the integral (of the window function) is the integral itself.

As another alternative (third approach), the integrating unit 120 integrates the window function with infinitesimally small increments in the window size by approximating the window function with a power series and finding a limit of the power series and utilize the limit as the integral. In some embodiments, the limit is a limit inferior. Alternatively, the limit is a limit superior. In some embodiments, limits of one or more power series are stored in a memory together with the associated power series. Thus, the integrating unit 120 may retrieve the limit of the power series directly from the memory.

As yet another alternative (fourth approach), the power series of the window function is known (e.g., since the window function has been selected as a known power series). The integrating unit 120 integrates the window function with infinitesimally small increments in the window size by finding the limit of the known power series and utilizing the limit as the integral.

As a further alternative (fifth approach), the integrating unit 120 integrates the window function with infinitesimally small increments in the window size by performing the first and third approaches (described above) and thereafter selecting a (arithmetic or geometric) mean or median value (or an array of mean or median values) of the end results (i.e., integrals) of the first and third approaches as the integral.

Furthermore, the transform unit 110 is configured to remap the time-continuous signal to one or more time-frequency space coefficients based on (e.g., in accordance with or in dependence of) the calculated/obtained integral. Thus, in some embodiments, the transform unit 110 receives the integral (or the value/array of values of the integral) from the integrating unit 120. In some embodiments, a transmitter 190 (or a transceiver) comprises the remapping unit 100. The transmitter 190 (or the transceiver) is (configured) for wireless transmission (or for wireline/wired transmission, i.e., transmission over/via cables and/or optical fibers), e.g., the transmitter is configured to transmit data (to a remote receiver) wirelessly. In some embodiments, the transmitter 190 comprises one or more antennas 700 for transmitting radio signals (including data, such as one or more time-frequency space coefficients) to a remote receiver. Furthermore, the transmitter 190 may comprise transmitting/transceiving equipment necessary for the transmission (and reception) of radio signals including one or more low noise amplifiers (LNAs), one or more variable gain amplifiers (VGAs), one or more power amplifiers (PAs), one or more phase locked loops (PLLs), one or more mixers, one or more analog-to-digital converters (ADCs), one or more digital-to-analog converters (DACs), one or more filters and/or one or more processors, such as one or more baseband (BB) processors. Moreover, in some embodiments, the transmitter 190 comprises a modulator 130. The modulator 130 modulates or is configured to modulate the one or more time-frequency space coefficients (remapped from the time-continuous signal) with a carrier signal. In some embodiments, a wireless device, WD, comprises the transmitter 190. Furthermore, in some embodiments, a repeater comprises the remapping unit 100.

FIG. 2 illustrates an inverse remapping unit according to some embodiments. The inverse remapping unit 200 is (configured) for remapping one or more time-frequency space coefficients to a time-continuous signal utilizing an inverse transform. In some embodiments, the inverse transform is a Fourier-related inverse transform. The Fourier-related inverse transform is a windowed inverse Fourier transform, an inverse Hartley transform, an inverse variable-Q transform (IVQT) or an inverse constant-Q transform (ICQT). Alternatively, the inverse transform is an inverse continuous wavelet transform (ICWT). As another alternative, the inverse transform is an inverse superlet transform (ISLT). The inverse remapping unit 200 comprises an inverse transform unit 210. The inverse transform unit 210 receives or is configured to receive one or more time-frequency space coefficients. Furthermore, the inverse transform unit 210 is configured to inverse-multiply the received time-continuous signal with a window function (to obtain a multiplicative inverse). The window function has a window size. Furthermore, the window function comprises one or more functions, e.g., basis functions. In some embodiments, the window function is the same window function utilized by the transform unit 110 described above in connection with FIG. 1. In some embodiments, the inverse transform unit 210 receives the same input as the transform unit 110. The inverse remapping unit 200 comprises an integrating unit 220 configured to integrate the window function with infinitesimally small increments in the window size to obtain an integral. In some embodiments, the integral is the same integral as described above for the remapping unit 100 in connection with FIG. 1. I.e., in some embodiments, the integral is obtained according to one or more of the first, second, third, fourth, and fifth approaches described above in connection with FIG. 1. Thus, in some embodiments, the integral is obtained in the same manner as described above in connection with FIG. 1. The integrating unit 220 may receive the window function from a memory unit external to the integrating unit 220, e.g., comprised in the remapping unit 100. Alternatively, the window function is stored internally in the integrating unit 220. Furthermore, the inverse transform unit 210 remaps or is configured to remap the one or more time-frequency space coefficients to a time-continuous signal based on (e.g., in accordance with or in dependence of) the integral. Thus, in some embodiments, the inverse transform unit 210 receives the integral (or the value of the integral) from the integrating unit 220. Furthermore, in some embodiments, a receiver 290 (or a transceiver) comprises the inverse remapping unit 200. The receiver 290 (or the transceiver) is (configured) for wireless transmission (or for wireline/wired transmission, i.e., transmission over/via cables and/or optical fibers), e.g., the receiver 290 is configured to receive data, such as one or more time-frequency space coefficients, (from a remote transmitter) wirelessly. In some embodiments, the receiver 290 comprises one or more antennas 705 for receiving radio signals from a remote transmitter. Furthermore, the receiver 290 may comprise (or is associated with) receiving/transceiving equipment necessary for the transmission/reception of radio signals including one or more low noise amplifiers (LNAs), one or more variable gain amplifiers (VGAs), one or more power amplifiers (PAs), one or more phase locked loops (PLLs), one or more mixers, one or more analog-to-digital converters (ADCs), one or more digital-to-analog converters (DACs), one or more filters and/or one or more processors, such as baseband (BB) processors. Moreover, in some embodiments, the receiver 290 comprises a demodulator 230. The demodulator 230 demodulates or is configured to demodulate the modulated carrier signal to extract the one or more time-frequency space coefficients. In some embodiments, a WD comprises the receiver 290. Furthermore, in some embodiments, a repeater comprises the inverse remapping unit 200.

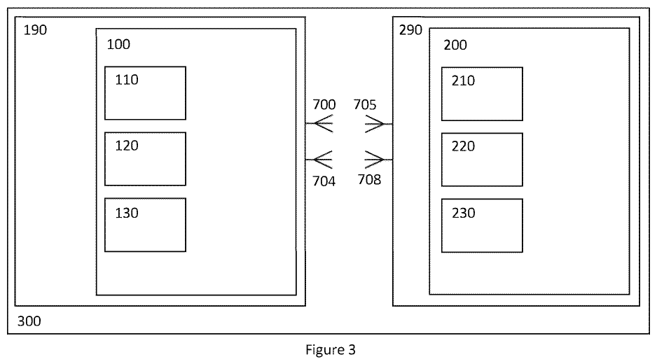

FIG. 3 illustrates a system 300 for wireless transmission (or for wireline/wired transmission, i.e., transmission over/via cables and/or optical fibers), such as wireless data transmission or wireless digital transmission, according to some embodiments. The system 300 comprises one or more transmitters 190 as described above in connection with FIG. 1. Moreover, in some embodiments, each of the one or more transmitters 190 comprises a modulator 130. The modulator 130 receives the one or more time-frequency space coefficients from the remapping unit 100, which has remapped the time-continuous signal as described above in connection with FIG. 1. Furthermore, the modulator 130 modulates or is configured to modulate the one or more time-frequency space coefficients with a carrier signal to obtain a modulated carrier signal. Moreover, the modulated carrier signal is transmitted wirelessly via one or more antennas 700, 704 (or via wires/cables/optical fibers) to a remote receiver, such as the receiver 290. The system 300 comprises one or more receivers 290 as described above in connection with FIG. 2. Moreover, in some embodiments, each of the one or more receivers 290 comprises a demodulator 230. The demodulator 230 demodulates or is configured to demodulate the modulated carrier signal received wirelessly via one or more antennas 705 (or via wires/cables/optical fibers), 708 from a remote transmitter, such as the transmitter 190, to extract the one or more time-frequency space coefficients. The extracted one or more time-frequency space coefficients are then sent to the inverse transform unit 210. The inverse transform unit 210 inverse-transforms the one or more time-frequency space coefficients to obtain the time-continuous signal. Thus, a time-continuous signal remapped at a transmitter 190 may be reconstructed at the receiver 290.

By utilizing the system 300, a more efficient wireless (or wired) transmission is achieved. In some embodiments, the system performs the wireless transmission according to a standard, i.e., a wireless (or wired) transmission standard, such as 3G, 4G, 5G, Long-Term Evolution, LTE, Wi-Fi, Digital subscriber line, DSL, or any future standard, such as 6G. Furthermore, in some embodiments, the system comprises one or more wireless devices, WD, and one or more base stations, BS. The one or more WDs may each comprise a transmitter 190 and a receiver 290 (both as described above). Furthermore, the one or more BSs may comprise one or more transmitters 190 and one or more receivers 290 (e.g., both as described above). Each WD may then communicate with, i.e., transmit signals, such as speech, to and receive signals, such as speech, from, another WD via a BS. Moreover, in some embodiments, the system performs the wireless (or wired) transmission utilizing multiplexing, such as orthogonal frequency division multiplexing (OFDM), Wavelet-OFDM, frequency-division multiplexing (FDM), or Non-orthogonal frequency-division multiplexing (N-OFDM). When utilizing the system 300 for performing (wireless) data transmission with OFDM, efficiency is increased and/or transmission speed is increased.

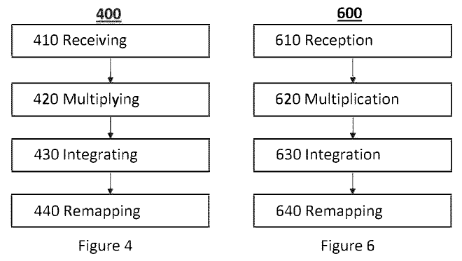

FIG. 4 illustrates method steps according to some embodiments. The method 400 is computer-implemented or hardware-implemented. Furthermore, the method 400 is for remapping a time-continuous signal to one or more time-frequency space coefficients. The method 400 comprises receiving 410, e.g., by a transmitter 190 or by a remapping unit 100 thereof and/or by a transform unit 110 of the remapping unit 100, a time-continuous signal. Furthermore, the method 400 comprises receiving 410 a frequency band of interest, e.g., by a transmitter 190 and/or by a remapping unit 100 thereof. In some embodiments, the frequency band of interest is as described above in connection with FIG. 1. Moreover, the method 400 comprises multiplying 420, by the remapping unit 100 or by the transform unit 110 thereof, the received time-continuous signal with a window function. The window function has a window size. Furthermore, the window function comprises one or more functions, such as one or more basis functions, e.g., one or more of the functions described above in connection with FIG. 1. The method 400 comprises integrating 430, by the remapping unit 100 or by an integrating unit 120 thereof, the window function with infinitesimally small increments in the window size to obtain an integral (value). In some embodiments, the integrating 430 is performed according to one or more of the first, second, third, fourth, and fifth approaches described above in connection with FIG. 1. Furthermore, the method 400 comprises remapping 440, by the remapping unit 100 or by the transform unit 110 thereof, the received time-continuous signal to one or more time-frequency space coefficients based on (e.g., in accordance with or in dependence of) the integral. By integrating the window function with infinitesimally small increments in the window size, a more efficient remapping is provided, e.g., since the integral can be calculated in one iteration instead of in many iterations.

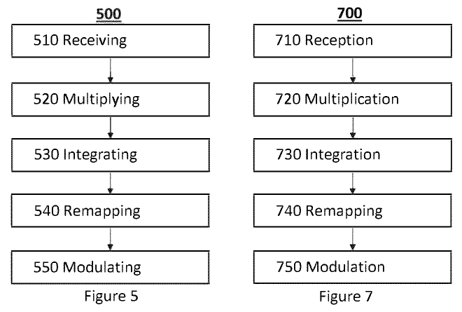

FIG. 5 illustrates method steps according to some embodiments. The method 500 is computer-implemented or hardware-implemented. Furthermore, the method 500 is for wireless transmission (or for wireline/wired transmission, i.e., transmission over/via cables and/or optical fibers), such as wireless data transmission or wireless digital transmission. The method 500 comprises receiving 510, e.g., by a transmitter 190 or by a remapping unit 100 thereof and/or by a transform unit 110 of the remapping unit 100, a time-continuous signal and a frequency band of interest. In some embodiments, the frequency band of interest is as described above in connection with FIG. 1. Furthermore, the method 500 comprises multiplying 520, by the remapping unit 100 or by the transform unit 110 thereof, the received time-continuous signal with a window function. The window function has a window size. Furthermore, the window function comprises one or more functions, such as one or more basis functions, e.g., one or more of the functions described above in connection with FIG. 1. The method 500 comprises integrating 530, e.g., by the integrating unit 120, the window function with infinitesimally small increments in the window size. Thereby an integral is obtained. In some embodiments, the integrating 530 is performed according to one or more of the first, second, third, fourth, and fifth approaches described above in connection with FIG. 1. Furthermore, the method 500 comprises remapping 540, by the remapping unit 100 or by the transform unit 110 thereof, the received time-continuous signal to one or more time-frequency space coefficients based on (e.g., in accordance with or in dependence of) the integral. Moreover, the method 500 comprises modulating 550, e.g., by the modulator 130, the one or more time-frequency space coefficients with a carrier signal. Thereby, a modulated carrier signal is generated. In some embodiments, the modulating 550 comprises utilizing OFDM. Thus, the modulating 550 may involve encoding digital data, i.e., the one or more time-frequency space coefficients, on multiple carrier frequencies. In some embodiments, the method 500 comprises transmitting the generated modulated carrier signal, e.g., by transmitting circuitry or by a transceiver. By integrating the window function with infinitesimally small increments in the window size, a more efficient digital transmission is provided, e.g., since the integral can be calculated in one iteration instead of in many iterations, thus providing faster transmission of data and/or transmission of more data during the same time period (e.g., transmission of data with a higher rate).

FIG. 6 illustrates method steps, e.g., the method steps of the method 400, implemented in an apparatus 600 for remapping a time-continuous signal to one or more time-frequency space coefficients, in a wireless device, WD, or in a control unit/control circuitry thereof, according to some embodiments. Thus, in some embodiments, a WD comprises the apparatus 600. Alternatively, a control unit, comprised in a WD, comprises the apparatus 600. As yet another alternative, a base station, such as an eNodeB or a gNodeB, comprises the apparatus 600. The apparatus 600 comprises controlling circuitry. The controlling circuitry may be one or more processors, such as a baseband, BB, processor. The controlling circuitry is configured to cause reception 610 of a time-continuous signal and a frequency band of interest. To this end, the controlling circuitry may be associated with (e.g., operatively connectable, or connected, to) a receiving unit (e.g., receiving circuitry, the transmitter 190, the remapping unit 100, or the transform unit 110). Furthermore, the controlling circuitry is configured to cause multiplication 620 of the received time-continuous signal with a window function. To this end, the controlling circuitry may be associated with (e.g., operatively connectable, or connected, to) a multiplying unit (e.g., multiplying circuitry, a multiplier, the remapping unit 100 or the transform unit 110). Moreover, the controlling circuitry is configured to cause integration 630 of the window function with infinitesimally small increments in the window size to obtain an integral. To this end, the controlling circuitry may be associated with (e.g., operatively connectable, or connected, to) an integration unit (e.g., integrating circuitry, an integrator, or the integrating unit 120. The controlling circuitry is configured to cause remapping 640 of the received time-continuous signal to one or more time-frequency space coefficients based on (e.g., in accordance with or in dependence of) the integral. To this end, the controlling circuitry may be associated with (e.g., operatively connectable, or connected, to) a remap unit (e.g., remapping circuitry, a remapper, the remapping unit 100 or the transform unit 110).

FIG. 7 illustrates method steps, e.g., the method steps of the method 500, implemented in an apparatus 700 for wireless transmission (or for wireline/wired transmission, i.e., transmission over/via cables and/or optical fibers), such as wireless data transmission or wireless digital transmission, in a wireless device or in a control unit/control circuitry thereof, according to some embodiments. Thus, in some embodiments, a WD comprises the apparatus 700. Alternatively, a control unit, comprised in a WD, comprises the apparatus 700. As yet another alternative, a base station, such as an eNodeB or a gNodeB, comprises the apparatus 700. The apparatus 700 comprises controlling circuitry. The controlling circuitry may be one or more processors, such as a baseband, BB, processor. The controlling circuitry is configured to cause reception 710 of a time-continuous signal and a frequency band of interest. To this end, the controlling circuitry may be associated with (e.g., operatively connectable, or connected, to) a receiving unit (e.g., receiving circuitry, the transmitter 190, the remapping unit 100, or the transform unit 110). Furthermore, the controlling circuitry is configured to cause multiplication 720 of the received time-continuous signal with a window function. To this end, the controlling circuitry may be associated with (e.g., operatively connectable, or connected, to) a multiplying unit (e.g., multiplying circuitry, a multiplier, the remapping unit 100 or the transform unit 110). Moreover, the controlling circuitry is configured to cause integration 730 of the window function with infinitesimally small increments in the window size to obtain an integral. To this end, the controlling circuitry may be associated with (e.g., operatively connectable, or connected, to) an integration unit (e.g., integrating circuitry, an integrator, or the integrating unit 120. The controlling circuitry is configured to cause remapping 740 of the received time-continuous signal to one or more time-frequency space coefficients based on (e.g., in accordance with or in dependence of) the integral. To this end, the controlling circuitry may be associated with (e.g., operatively connectable, or connected, to) a remap unit (e.g., remapping circuitry, a remapper, the remapping unit 100 or the transform unit 110). Furthermore, the controlling circuitry is configured to cause modulation 750 of the one or more time-frequency space coefficients with a carrier signal (and transmitting the generated modulated carrier signal). To this end, the controlling circuitry may be associated with (e.g., operatively connectable, or connected, to) a modulating unit (e.g., modulating circuitry, or the modulator 130) and optionally transmitting circuitry (e.g., one or more transceivers and one or more associated antennas).

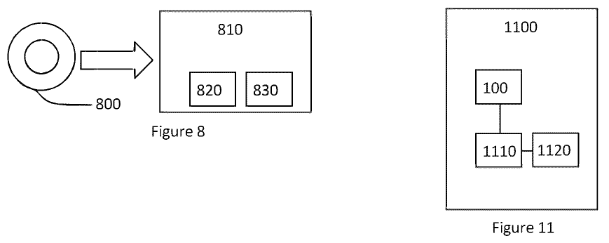

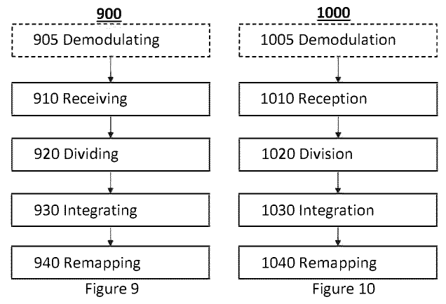

According to some embodiments, a computer program product comprising a non-transitory computer readable medium 800, such as a punch card, a compact disc (CD) ROM, a read only memory (ROM), a digital versatile disc (DVD), an embedded drive, a plug-in card, a random-access memory (RAM) or a universal serial bus (USB) memory, is provided. FIG. 8 illustrates an example computer readable medium in the form of a compact disc (CD) ROM 800. The computer readable medium has stored thereon, a computer program comprising program instructions. The computer program is loadable into a data processor (PROC) 820, which may, for example, be comprised in a computer 810 or a computing device, a processing unit, or a control unit. When loaded into the data processor, the computer program may be stored in a memory (MEM) 830 associated with or comprised in the data processor. According to some embodiments, the computer program may, when loaded into and run by the data processor, cause execution of method steps according to, for example, any one of the method 400 illustrated in FIG. 4, the method 500 illustrated in FIG. 5, the method 900 illustrated in FIG. 9, or all methods 400, 500, 900 described herein. Furthermore, in some embodiments, there is provided a computer program product comprising instructions, which, when executed on at least one processor of a processing device, cause the processing device to carry out one or more of the methods illustrated in FIG. 4, FIG. 5 and FIG. 9. Moreover, in some embodiments, there is provided a non-transitory computer-readable storage medium storing one or more programs configured to be executed by one or more processors of a processing device, the one or more programs comprising instructions which, when executed by the processing device, causes the processing device to carry out one or more of the methods illustrated in FIG. 4, FIG. 5 and FIG. 9.

FIG. 9 illustrates method steps of a method 900 according to some embodiments. The method 900 is for remapping one or more time-frequency space coefficients to a time-continuous signal utilizing an inverse transform. Furthermore, the method 900 is computer-implemented or hardware-implemented. The method 900 comprises receiving 910, e.g., by the inverse transform unit 210, one or more time-frequency space coefficients. Furthermore, the method 900 comprises inverse-multiplying 920, e.g., by the inverse transform unit 210, the received time-continuous signal with a window function. Alternatively, the method 900 comprises dividing or inverting, e.g., by the inverse transform unit 210, the received time-continuous signal with a window function. Moreover, the method 900 comprises integrating 930, e.g., by the integrating unit 220, the window function with infinitesimally small increments in the window size to obtain an integral. In some embodiments, the integral is the same integral as described above for the remapping unit 100 in connection with FIG. 1. I.e., in some embodiments, the integrating 930 is performed according to one or more of the first, second, third, fourth, and fifth approaches described above in connection with FIG. 1. The method comprises remapping 940, e.g., by the inverse transform unit 210, the one or more time-frequency space coefficients to a time-continuous signal based on (e.g., in accordance with or in dependence of) the integral.

Furthermore, in some embodiments, the method 900 comprises demodulating 905, e.g., by the demodulator 230, a modulated carrier signal to extract one or more time-frequency space coefficients. In these embodiments, the inverse transform unit 210 receives the one or more time-frequency space coefficients from the demodulator 230. In some embodiments, the demodulating 905 comprises utilizing OFDM. Thus, the demodulating 905 may involve decoding digital data, i.e., the one or more time-frequency space coefficients, from multiple carrier frequencies.

FIG. 10 illustrates method steps, e.g., the method steps of the method 900, implemented in an apparatus 1000 for wireless transmission (or for wireline/wired transmission, i.e., transmission over/via cables and/or optical fibers), such as wireless data transmission or wireless digital transmission, in a wireless device or in a control unit/control circuitry thereof, according to some embodiments. Thus, in some embodiments, a WD comprises the apparatus 1000. Alternatively, a control unit, comprised in a WD, comprises the apparatus 1000. As yet another alternative, a base station, such as an eNodeB or a gNodeB, comprises the apparatus 1000. The apparatus 1000 comprises controlling circuitry. The controlling circuitry may be one or more processors, such as a baseband, BB, processor. The controlling circuitry is configured to cause reception 1010 of one or more time-frequency space coefficients. To this end, the controlling circuitry may be associated with (e.g., operatively connectable, or connected, to) a receiving unit (e.g., receiving circuitry, or the inverse transform unit 210). Furthermore, the controlling circuitry is configured to cause inverse-multiplication 1020 of the received time-continuous signal with a window function. To this end, the controlling circuitry may be associated with (e.g., operatively connectable, or connected, to) an inverse-multiplying unit (e.g., inverse-multiplying circuitry, an inverse-multiplier, or the inverse transform unit 210). Moreover, the controlling circuitry is configured to cause integration 1030 of the window function with infinitesimally small increments in the window size to obtain an integral (value). To this end, the controlling circuitry may be associated with (e.g., operatively connectable, or connected, to) an integration unit (e.g., integrating circuitry, an integrator, or the integrating unit 220). The controlling circuitry is configured to cause remapping 1040 of the one or more time-frequency space coefficients to a time-continuous signal based on (e.g., in accordance with or in dependence of) the integral. To this end, the controlling circuitry may be associated with (e.g., operatively connectable, or connected, to) a remapping unit (remapping circuitry, a remapper, the inverse remapping unit 200, or the inverse transform unit 210). Moreover, in some embodiments, the controlling circuitry is configured to cause demodulation 1005 of a modulated carrier signal to extract one or more time-frequency space coefficients. To this end, the controlling circuitry may be associated with (e.g., operatively connectable, or connected, to) a demodulating unit (demodulating circuitry, or the demodulator 230). In these embodiments, reception 1010 of one or more time-frequency space coefficients involves reception of the one or more time-frequency space coefficients from the demodulator 230.

Alternatively, in some embodiments, the remapping unit 100 illustrated in FIG. 1 and described in connection therewith is utilized in a system for data processing 1100 depicted in FIG. 11. Thus, a data processing system 1100 comprises the remapping unit 100. The data processing system further comprises an identification unit 1110 for identifying specific signatures or for recognizing patterns in the input data, i.e., in the time-continuous signal, by comparing the one or more time-frequency space coefficients to one or two or more known/stored (e.g., stored in a memory unit 1120 associated with and/or connected to the identification unit 1110) sets of time-frequency space coefficients (for the frequency band of interest), each known/stored set associated with a specific signature/pattern (also stored, e.g., in the memory 1120 and associated with the corresponding set of time-frequency space coefficients), to find a closest match of the one or more time-frequency space coefficients to the known/stored one or two or more sets of time-frequency space coefficients, and identifying/recognizing the (specific) signature/pattern as the (known/stored) signature/pattern which is associated with the stored set of time-frequency space coefficients which is the closest match for the one or more time-frequency space coefficients.

In some embodiments, the time-continuous signal is an audio signal and the identification unit 1110 identifies an entity, such as a speaker, a spoken letter, a syllable, a word, a phrase or a phoneme, present in the audio signal, e.g., by comparing the one or more time-frequency space coefficients to each of one or more stored (e.g., stored in a memory unit 1120 associated with and/or connected to the identification unit 1110) sets of time-frequency space coefficients (for the frequency band of interest), each stored set associated with a specific entity, to find a closest match of the one or more time-frequency space coefficients to the stored sets of time-frequency space coefficients, and identifying the entity as the entity (i.e., the speaker, spoken letter, syllable, word, phrase or phoneme) which is associated with the stored set of time-frequency space coefficients which is the closest match for the one or more time-frequency space coefficients.

By utilizing a data processing system comprising the remapping unit 100, the precision and/or reliability of identification of specific signatures or entities, such as speakers, spoken letters, syllables, words, phrases, or phonemes, in the input data is improved/increased. Furthermore, the capacity of the data processing system to handle more complex data, e.g., with multiple overlaid data signatures/entities, is improved/increased.

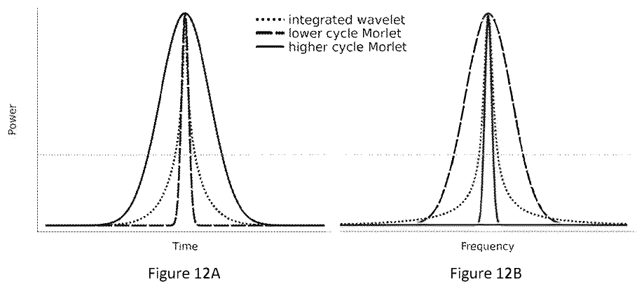

FIG. 12A illustrates time-power for a higher-temporal resolution Morlet wavelet, for a higher-frequency-resolution Morlet wavelet and for a singular integrated-wavelet and FIG. 12B illustrates frequency-power for a higher-temporal resolution Morlet wavelet, for a higher-frequency-resolution Morlet wavelet and for a singular integrated-wavelet. The number of cycles of the higher-temporal resolution Morlet wave is 5, the number of cycles of the higher-frequency resolution Morlet wave is 35. The dashed line is placed at 33% of the peak power. As can be seen from FIGS. 12A-B, the higher-temporal resolution Morlet wave has a better resolution in time than the higher-frequency-resolution Morlet wavelet and the singular integrated-wavelet of the present invention. Furthermore, the higher-frequency resolution Morlet wave has a better resolution in frequency than the higher-temporal resolution Morlet wavelet and the singular integrated-wavelet of the present invention. However, the singular integrated-wavelet of the present invention has a better resolution in frequency than the higher-temporal resolution Morlet wavelet and a better resolution in time than the higher-frequency-resolution Morlet wavelet. Thus, time-frequency resolution is improved/increased by utilizing the singular integrated-wavelet of the present invention (i.e., by utilizing the integrated window function, integrated by the integrating unit 120). Furthermore, by integrating the window function with infinitesimally small increments in the window size to obtain an integral, a more efficient remapping is provided, e.g., since the integral can be calculated in one iteration instead of in many iterations. Moreover, energy consumption to achieve a given desired time-frequency resolution is lowered/decreased, e.g., since the integral can be calculated in one iteration instead of in many iterations.

### LIST OF EXAMPLES

Example 1. A remapping unit (100) for remapping a time-continuous signal to one or more time-frequency space coefficients utilizing a transform, the remapping unit comprising:
a transform unit (110) configured to receive the time-continuous signal and a frequency band of interest, and configured to multiply the received time-continuous signal with a window function having a window size, the window function comprising one or more functions;
an integrating unit (120) configured to integrate the window function with infinitesimally small increments in the window size to obtain an integral; and
wherein the transform unit (110) is configured to remap the time-continuous signal to one or more time-frequency space coefficients based on the obtained integral.

Example 2. The remapping unit of example 1, wherein the one or more functions comprises one or more sinusoidal basis functions, one or more Morlet wavelets, or one or more modified complex Morlet wavelets.

Example 3. The remapping unit of any of examples 1-2, wherein the transform is a Fourier-related transform, such as a windowed Fourier transform or a Hartley transform, or a continuous wavelet transform, CWT, or a superlet transform, SLT.

Example 4. A transmitter (190) for wireless transmission comprising the remapping unit (100) of any of examples 1-3.

Example 5. An inverse remapping unit (200) for remapping one or more time-frequency space coefficients to a time-continuous signal utilizing an inverse transform, the inverse remapping unit comprising:
an inverse transform unit (210) is configured to receive one or more time-frequency space coefficients and configured to inverse-multiply the received time-continuous signal with a window function having a window size, the window function comprising one or more functions;
an integrating unit (220) configured to integrate the window function with infinitesimally small increments in the window size to obtain an integral; and
wherein the inverse transform unit (210) is configured to remap the one or more time-frequency space coefficients to a time-continuous signal based on the integral.

Example 6. A receiver (290) for wireless transmission comprising the inverse remapping unit (200) of example 5.

Example 7. A system (300) for wireless transmission, comprising:
the transmitter (190) of example 4 further comprising a modulator (130) configured to modulate the one or more time-frequency space coefficients with a carrier signal; and
the receiver (290) of example 6 further comprising a demodulator (230) configured to demodulate the modulated carrier signal to extract the one or more time-frequency space coefficients.

Example 8. A computer-implemented or hardware-implemented method (400) for remapping a time-continuous signal to one or more time-frequency space coefficients, comprising:
receiving (410) a time-continuous signal and a frequency band of interest;
multiplying (420) the received time-continuous signal with a window function having a window size, the window function comprising one or more functions;
integrating (430) the window function with infinitesimally small increments in the window size to obtain an integral; and
remapping (440) the received time-continuous signal to one or more time-frequency space coefficients based on the integral.

Example 9. A computer-implemented or hardware-implemented method (500) for wireless transmission, comprising:
receiving (510) a time-continuous signal and a frequency band of interest;
multiplying (520) the received time-continuous signal with a window function having a window size, the window function comprising one or more functions;
integrating (530) the window function with infinitesimally small increments in the window size to obtain an integral;
remapping (540) the received time-continuous signal to one or more time-frequency space coefficients based on the integral; and
modulating (550) the one or more time-frequency space coefficients with a carrier signal.

Example 10. A computer program product comprising a non-transitory computer readable medium (800), having stored thereon a computer program comprising program instructions, the computer program being loadable into a data processing unit (820) and configured to cause execution of the method according to any of examples 8-9 when the computer program is run by the data processing unit (820).

The person skilled in the art realizes that the present disclosure is not limited to the preferred embodiments described above. The person skilled in the art further realizes that modifications and variations are possible within the scope of the appended claims. Additionally, variations to the disclosed embodiments can be understood and effected by the skilled person in practicing the claimed disclosure, from a study of the drawings, the disclosure, and the appended claims.

1. A remapping unit for remapping a time-continuous signal to one or more time-frequency space coefficients utilizing a transform, the remapping unit comprising:
a transform unit configured to receive the time-continuous signal and a frequency band of interest, and configured to multiply the received time-continuous signal with a window function having a window size, the window function comprising one or more functions;
an integrating unit configured to integrate the window function with small increments in the window size to obtain an integral, wherein the increments in the window size are equivalent mathematically to infinitesimally small increments; and
wherein the transform unit is configured to remap the time-continuous signal to one or more time-frequency space coefficients based on the obtained integral.

2. The remapping unit of claim 1, wherein the one or more functions comprises one or more sinusoidal basis functions, one or more Morlet wavelets, or one or more modified complex Morlet wavelets.

3. The remapping unit of claim 1, wherein the window function is integrated with increments in the window size which are equivalent mathematically to infinitesimally small increments in the window size by:
utilizing a pre-defined antiderivative function of the integrand of the integral, calculating the antiderivative function with an upper bound of integration to obtain a first function value, calculating the antiderivative function with a lower bound of integration to obtain a second function value, and calculating the integral as the difference between the first and the second function values.

4. The remapping unit of claim 1, wherein the window function is integrated with increments in the window size which are equivalent mathematically to infinitesimally small increments in the window size by utilizing a pre-defined antiderivative function of the integrand of the integral, calculating the antiderivative function with an upper bound of a subrange of the frequency band of interest to obtain a first function value, calculating the antiderivative function with a lower bound of a sub-range of the frequency band of interest to obtain a second function value, and calculating the integral as the difference between the first and the second function values.

5. The remapping unit of claim 1, wherein the window function is integrated with increments in the window size which are equivalent mathematically to infinitesimally small increments in the window size by approximating the window function with a power series and finding a limit of the power series and utilize the limit as the integral.

6. The remapping unit of claim 1, wherein the window function is integrated with increments in the window size which are equivalent mathematically to infinitesimally small increments in the window size by finding the limit of a known power series and utilizing the limit as the integral.

7. The remapping unit of claim 1, wherein the window function is integrated with increments in the window size which are equivalent mathematically to infinitesimally small increments in the window size by utilizing a pre-defined antiderivative function of the integrand of the integral, calculating the antiderivative function with an upper bound of integration to obtain a first function value, calculating the antiderivative function with a lower bound of integration to obtain a second function value, and calculating a first integral as the difference between the first and the second function values, by approximating the window function with a power series and finding a limit of the power series and utilize the limit as a second integral, and wherein the integrating unit is configured to select a mean value or a median value of the first and second integrals as the integral.

8. The remapping unit of claim 1, wherein the integral is part of the calculations performed for the remapping.

9. (canceled)

10. The remapping unit of claim 1, wherein the transform is a Fourier-related transform.

11. The remapping unit of claim 1, wherein the remapping unit is configured as a component of a transmitter, the transmitter comprising a modulator configured to modulate the one or more time-frequency space coefficients with a carrier signal for wireline communication or for wireless transmission.

12. An inverse remapping unit for remapping one or more time-frequency space coefficients to a time-continuous signal utilizing an inverse transform, the inverse remapping unit comprising:
an inverse transform unit is configured to receive one or more time-frequency space coefficients and configured to inverse-multiply the received time-continuous signal with a window function having a window size, the window function comprising one or more functions; and
an integrating unit configured to integrate the window function with increments equivalent mathematically to infinitesimally small increments in the window size to obtain an integral; and
wherein the inverse transform unit is configured to remap the one or more time-frequency space coefficients to a time-continuous signal based on the integral.

13. The inverse remapping unit of claim 12, wherein the window function is integrated with increments equivalent mathematically to infinitesimally small increments in the window size by:
utilizing a pre-defined antiderivative function of the integrand of the integral, calculating the antiderivative function with an upper bound of integration to obtain a first function value, calculating the antiderivative function with a lower bound of integration to obtain a second function value, and calculating the integral as the difference between the first and the second function values.

14. The inverse remapping unit of claim 12, wherein the window function is integrated with increments equivalent mathematically to infinitesimally small increments in the window size by utilizing a pre-defined antiderivative function of the integrand of the integral, calculating the antiderivative function with an upper bound of a subrange of the frequency band of interest to obtain a first function value, calculating the antiderivative function with a lower bound of a sub-range of the frequency band of interest to obtain a second function value, and calculating the integral as the difference between the first and the second function values.

15. The inverse remapping unit of claim 12, wherein the window function is integrated with increments equivalent mathematically to infinitesimally small increments in the window size by approximating the window function with a power series and finding a limit of the power series and utilize the limit as the integral.

16. (canceled)

17. (canceled)

18. The inverse remapping unit of claim 12, wherein the integral is part of the calculations performed for the remapping.

19. (canceled)

20. The inverse remapping unit of claim 12 configured as a component of a receiver of a modulated carrier signal transmitted by wireline communication or wireless transmission, the receiver comprising a demodulator configured to demodulate the modulated carrier signal to extract the one or more time-frequency space coefficients.

21. A system for wireline communication or for wireless transmission of a communications signal, comprising:
a transmitter; and
a receiver,
wherein the transmitter comprises:
a remapping unit for remapping a time-continuous signal to one or more time-frequency space coefficients utilizing a transform, the remapping unit comprising:
a transform unit configured to receive the time-continuous signal and a frequency band of interest, and configured to multiply the received time-continuous signal with a window function having a window size, the window function comprising one or more functions;
an integrating unit configured to integrate the window function with small increments in the window size to obtain an integral, wherein the increments in the window size are equivalent mathematically to infinitesimally small increments; and
wherein the transform unit is configured to remap the time-continuous signal to one or more time-frequency space coefficients based on the obtained integral, and
wherein the transmitter further comprises a modulator configured to modulate the one or more time-frequency space coefficients with a carrier signal to form the communications signal for wireline communication or for wireless transmission,
and wherein the receiver comprises:
receiving a communications signal;
an inverse remapping unit for remapping one or more time-frequency space coefficients of the communications signal to a time-continuous signal utilizing an inverse transform, the inverse remapping unit comprising:
an inverse transform unit is configured to receive the one or more time-frequency space coefficients and configured to inverse-multiply the received time-continuous signal with a window function having a window size, the window function comprising one or more functions; and
an integrating unit configured to integrate the window function with increments equivalent mathematically to infinitesimally small increments in the window size to obtain an integral; and
wherein the inverse transform unit is configured to remap the one or more time-frequency space coefficients to a time-continuous signal based on the integral, and wherein the received communications signal comprises a modulated carrier signal transmitted by wireline communication or wireless transmission and the receiver further comprises a demodulator configured to demodulate the modulated carrier signal to extract the one or more time-frequency space coefficients.

22. The system of claim 21 comprising a repeater configured to perform repeat wireline communication or wireless transmission of the communication signal in the network.

23-42. (canceled)

43. The remapping unit of claim 1, wherein the transform is a Fourier-related transform selected from the group consisting of:
a windowed Fourier transform;
a Hartley transform;
a continuous wavelet transform, CWT, and
a superlet transform, SLT.
